(19) United States
(12) Patent Application Publication
(10) Pub. No.: US 2025/0173401 A1
(43) Pub. Date: May 29, 2025

(54) CONDITIONAL TEMPORAL DIFFUSION MODEL-BASED METHOD AND APPARATUS FOR GENERATING TIME SERIES OF INDUSTRIAL DEVICE, AND STORAGE MEDIUM

(71) Applicant: BEIHANG UNIVERSITY, Beijing (CN)

(72) Inventors: Lei REN, Beijing (CN); Haiteng WANG, Beijing (CN)

(21) Appl. No.: 18/627,956

(22) Filed: Apr. 5, 2024

(30) Foreign Application Priority Data
Nov. 28, 2023 (CN) 202311595067.X

(51) Int. Cl. G06F 18/214; G05B 19/418; G06F 123/02

(52) U.S. Cl. CPC G06F 18/214; G05B 19/4184; G06F 2123/02

(57) ABSTRACT

A conditional temporal diffusion model-based method and apparatus for generating a time series of an industrial device, including: acquiring parameter indicator data for the time series of the industrial device; using a noise at a target time instant in a target Gaussian noise distribution as an initial variable of the time series; inputting the parameter indicator data and the initial variable into a noise prediction model constructed based on a conditional temporal diffusion model, to obtain a predictive noise output by the noise prediction model; denoising the predictive noise according to the initial variable, to obtain a target variable of the time series located at a previous time instant of the target time instant; and inputting the target variable and the parameter indicator data into the noise prediction model for an iteration, to generate the time series of the industrial device.

### CROSS-REFERENCE TO RELATED DISCLOSURE

This application claims priority to Chinese Patent Application No. 202311595067.X, filed on Nov. 28, 2023, which is hereby incorporated by reference in its entirety.

### TECHNICAL FIELD

The present application relates to the field of time series technology, and in particular to a conditional temporal diffusion model-based method and apparatus for generating a time series of an industrial device, and a storage medium.

### BACKGROUND

A time series of an industrial device (e.g., engine operation data) has the characteristics of poor data quality, high sampling frequency, high noise, involving complex time dependencies, etc.

Currently, the generation of the time series of the industrial device is mostly performed using a Generative Adversarial Nets (GAN) model.

However, due to the confrontation between a generator and a discriminator in the GAN model, it is difficult to converge in a GAN model training process, thereby causing the time series generation of the industrial device to be more difficult and less efficient.

### SUMMARY

The present application provides a conditional temporal diffusion model-based method and apparatus for generating a time series of an industrial device, and a storage medium, which can reduce the difficulty of generating the time series of the industrial device and improve the generation efficiency.

In a first aspect, the present application provides a conditional temporal diffusion model-based method for generating a time series of an industrial device, including:
acquiring parameter indicator data for the time series of the industrial device, where the parameter indicator data is related to a type of the time series;
using a noise at a target time instant in a target Gaussian noise distribution as an initial variable of the time series;
inputting the parameter indicator data and the initial variable into a noise prediction model constructed based on a conditional temporal diffusion model, to obtain a predictive noise output by the noise prediction model;
denoising the predictive noise according to the initial variable, to obtain a target variable of the time series located at a previous time instant of the target time instant; and
inputting the target variable and the parameter indicator data into the noise prediction model for an iteration, to generate the time series of the industrial device.

In one embodiment, the inputting the parameter indicator data and the initial variable into the noise prediction model constructed based on the conditional temporal diffusion model, to obtain the predictive noise output by the noise prediction model, includes:
inputting the initial variable into a convolutional layer of an embedding module of the noise prediction model, and performing convolution processing on the initial variable to obtain first data;
inputting the parameter indicator data into a fully connected layer of the embedding module of the noise prediction model, performing data transformation on the parameter indicator data to obtain a parameter indicator vector; and
inputting the first data and the parameter indicator vector into a UNet module of the noise prediction model, and performing reconstruction processing on the first data and the parameter indicator vector to obtain the predictive noise.

In one embodiment, the UNet module includes an encoder layer, a temporal decomposition reconstruction layer, a decoder layer, and a convolutional layer, and the performing the reconstruction processing on the first data and the parameter indicator vector to obtain the predictive noise includes:
embedding the parameter indicator vector into the encoder layer and the decoder layer;
inputting the first data into the encoder layer for encoding processing, to obtain second data;
inputting the second data into the temporal decomposition reconstruction layer for temporal decomposition reconstruction processing, to obtain third data; and
inputting the third data into the decoder layer for decoding processing to obtain fourth data, and inputting the fourth data into the convolutional layer for convolution processing, to obtain the predictive noise.

In one embodiment, the temporal decomposition reconstruction layer includes: a pooling layer, a convolutional layer, and an attention layer; and the inputting the second data into the temporal decomposition reconstruction layer for the temporal decomposition reconstruction processing to obtain the third data includes:
inputting the second data into the pooling layer for pooling processing, to obtain target feature data; where the target feature data includes peak feature data and trend feature data; and
inputting after concatenating the peak feature data and the trend feature data into the convolutional layer and the attention layer for processing, to obtain the third data.

In one embodiment, the method further includes:
acquiring a training sample, where the training sample includes a sample time series of at least one industrial device, parameter indicator data for the sample time series, a time step of the sample time series, and a label noise;
inputting the training sample into the noise prediction model to obtain a target noise output by the noise prediction model;
acquiring, according to the label noise and the target noise, an objective loss function of the noise prediction model by means of maximum mean discrepancy (MMD); and
training, according to the objective loss function, the noise prediction model by means of back propagation.

In one embodiment, the inputting the training sample into the noise prediction model to obtain the target noise output by the noise prediction model includes:
inputting the sample time series into a diffusion layer of an embedding module for noise diffusion, to obtain a latent variable of the sample time series;
inputting the latent variable of the sample time series into a convolutional layer of the embedding module, and performing convolution processing on the latent variable to obtain fifth data;
inputting the parameter indicator data and the time step into the fully connected layer of the embedding module for data processing respectively to obtain sixth data; and
inputting the fifth data and the sixth data into a UNet module for processing, to obtain the target noise.

In one embodiment, the acquiring, according to the label noise and the target noise, the objective loss function of the noise prediction model by means of the maximum mean discrepancy (MMD) includes:
acquiring, according to the label noise and the target noise, a noise estimation loss function;
mapping the label noise and the target noise to a target dimension space to obtain a similarity function between the label noise and the target noise; and
obtaining the objective loss function according to the noise estimation loss function and the similarity function.

In one embodiment, the obtaining the objective loss function according to the noise estimation loss function and the similarity function includes:
performing additive processing on the noise estimation loss function and the similarity function to obtain the objective loss function.

In a second aspect, the present application provides a conditional temporal diffusion model-based apparatus for generating a time series of an industrial device, including: an acquiring module configured to acquire parameter indicator data for the time series of the industrial device, where the parameter indicator data is related to a type of the time series;
a determining module configured to use a noise at a target time instant in a target Gaussian noise distribution as an initial variable of the time series;
a processing module configured to input the parameter indicator data and the initial variable into a noise prediction model constructed based on a conditional temporal diffusion model, to obtain a predictive noise output by the noise prediction model;
a denoising module configured to denoise the predictive noise according to the initial variable, to obtain a target variable of the time series located at a previous time instant of the target time instant; and
an iterating module configured to input the target variable and the parameter indicator data into the noise prediction model for an iteration, to generate the time series of the industrial device.

In a third aspect, the present application provides an electronic device, including: a memory and a processor;
where the memory is configured to store a computer instruction; and the processor is configured to run the computer instruction stored in the memory to implement the method according to any item of the first aspect.

In a fourth aspect, the present application provides a computer readable storage medium, where a computer program is stored thereon, and the computer program is executed by a processor to implement the method according to any item of the first aspect.

In a fifth aspect, the present application provides a computer program product, including a computer program, where the method according to any item of the first aspect is implemented when the computer program is executed by a processor.

The present application provides a conditional temporal diffusion model-based method and apparatus for generating a time series of an industrial device, and a storage medium, by acquiring parameter indicator data for the time series of the industrial device, where the parameter indicator data is related to a type of the time series; using a noise at a target time instant in a target Gaussian noise distribution as an initial variable of the time series; inputting the parameter indicator data and the initial variable into a noise prediction model constructed based on a conditional temporal diffusion model, to obtain a predictive noise output by the noise prediction model; denoising the predictive noise according to the initial variable, to obtain a target variable of the time series located at a previous time instant of the target time instant; and inputting the target variable and the parameter indicator data into the noise prediction model for an iteration, to generate the time series of the industrial device. The generation of the time series of the industrial device by means of the noise prediction model constructed based on the conditional temporal diffusion model relieves the problem existing in the prior art that it is difficult to converge in a model training process, thereby improving the efficiency of the time series of the industrial device.

### BRIEF DESCRIPTION OF DRAWINGS

FIG. 1 is a structure diagram of a noise prediction model provided by an embodiment of the present application.

FIG. 2 is a flow diagram of a method for generating a time series of an industrial device provided by an embodiment of the present application.

FIG. 3 is a flow diagram of generating a predictive noise provided by an embodiment of the present application.

FIG. 4 is a structure diagram of a temporal decomposition reconstruction layer provided by an embodiment of the present application.

FIG. 5 is a flow diagram of a training method for a noise prediction model provided by an embodiment of the present application.

FIG. 6 is a diagram of a training process of a noise prediction model provided by an embodiment of the present application.

FIG. 7 is a structure diagram of an apparatus for generating a time series of an industrial device provided by an embodiment of the present application.

FIG. 8 is a structure diagram of an electronic device provided by an embodiment of the present application.

### DESCRIPTION OF EMBODIMENTS

In order to make purposes, technical solutions and advantages of the embodiments in the present application clearer, the technical solutions in the embodiments of the present application will be clearly and completely described below in combination with drawings in the embodiments of the present application. Obviously, the described embodiments are partial embodiments of the present application, not all of them. Based on the embodiments in the present application, all other embodiments obtained by persons of ordinary skill in the art without paying creative labors fall within the protection scope of the present application.

In the embodiments of the present application, words “first”, “second”, etc., are used to differentiate between the same or similar items with essentially the same functions and roles, without limiting the order thereof. Those skilled in the art can understand that the words “first” and “second” do not limit the number or the execution order, and the words “first” and “second” do not limit a necessity for being different.

It should be noted that in the embodiments of the present application, the term “exemplary” or “for example” is used to denote examples, illustrations, or descriptions. Any embodiment or design solution described as “exemplary” or “for example” in the present application should not be construed as being preferred or more advantageous than other embodiments or design solutions. Specifically, use of the term “exemplary” or “for example” is intended to present relevant concepts in a specific way.

A time series (or known as dynamic series) refers to a series of numbers in which values of a same statistical indicator are arranged based on the chronological order of their occurrence. A main purpose of a time series analysis is to predict the future according to existing historical data.

In an industrial scenario, prediction management of an industrial device using a time series of the industrial device (e.g., predicting a lifetime of an engine with operating data thereof) allows for an evaluation on a using process of the industrial device. To improve the accuracy of the prediction management on the industrial device, a plurality of time series of the industrial device with similarity are usually required.

In a related technology, a GAN model may be used to generate a plurality of time series of an industrial device with similarity based on an original time series of the industrial device.

However, the time series of the industrial device has the characteristics of poor data quality, high sampling frequency, high noise, involving complex temporal dependencies, etc., which makes it difficult for a generator in the GAN model to learn the patterns in time series data, causing generation of the time series of the industrial device using the GAN model to be more difficult and less efficient.

In view of this, the present application provides a conditional temporal diffusion model-based method and apparatus for generating a time series of an industrial device, and a storage medium, where generation of the time series of the industrial device is performed with a noise prediction model constructed based on the conditional temporal diffusion model, which can reduce the degree of difficulty in generating the time series of the industrial device, thereby improving the efficiency of generating the time series of the industrial device.

The technical solutions of the present application and how the technical solutions of the present application solve the above-mentioned technical problem are described in detail in the following specific embodiments. The following specific embodiments may be implemented independently or in combination with each other, and the same or similar concepts or processes may not be repeated in certain embodiments.

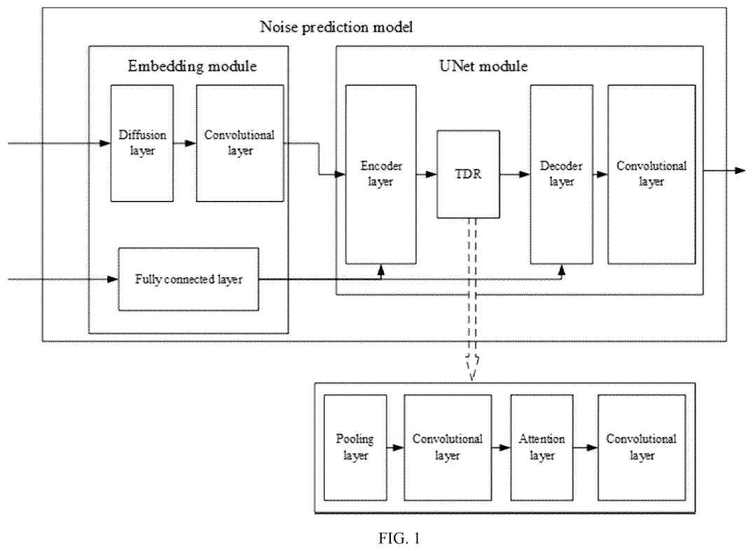

FIG. 1 is a diagram of a noise prediction model provided by an embodiment of the present application. As shown in FIG. 1, the noise prediction model may include an embedding module and a UNet module (which may also be referred to as a temporal decomposition reconstruction UNet module).

The embedding module may include a diffusion layer, a convolutional layer, and a fully connected layer. The UNet module may include an encoder layer, a convolutional layer, a decoder layer, and a temporal decomposition reconstruction (TDR) layer.

The temporal decomposition reconstruction layer may further include a pooling layer, a convolutional layer, and an attention layer.

The diffusion layer may perform diffusion processing on input data, gradually add a Gaussian noise to the data, and convert the data into a random noise.

The encoder layer may include at least one encoder which may perform feature learning on the input data, and the decoder layer may include at least one decoder which may perform semantic learning on the input data.

In some embodiments, the encoder may consist of a plurality of convolutional blocks, and each of the convolutional blocks includes a convolutional layer (typically a 3×3 convolutional kernel), a batch normalization, and an activation function (typically ReLU).

The decoder may consist of a plurality of deconvolutional blocks, each of the deconvolutional blocks includes a deconvolutional layer (also referred to as transposed convolution), a batch normalization, and an activation function.

The temporal decomposition reconstruction layer is configured to learn a time series feature of data, for example, to learn an average trend feature and a peak trend feature within the data. The attention layer may adopt an attention mechanism to perform processing on the input data.

In some embodiments, during a training process and a using process of the noise prediction model, the input data may be processed in different ways.

For example, in a training mode, when the embedding module of the noise prediction model receives the input data, the data may be processed according to a type of the input data by using the diffusion layer and the fully connected layer respectively and is then inputted to a subsequent structural layer for processing. For example, a time series in the input data is processed using the diffusion layer, and parameter indicator data for the time series is input into the fully connected layer for processing.

In a using mode, when the embedding module of the noise prediction model receives the input data, target noise in the input data is directly processed using the convolutional layer, and parameter indicator data is input into the fully connected layer for processing. That is, in the using mode, the diffusion layer may be skipped.

The method for generating a time series of an industrial device provided by an embodiment of the present application is described below based on the noise prediction model shown in FIG. 1.

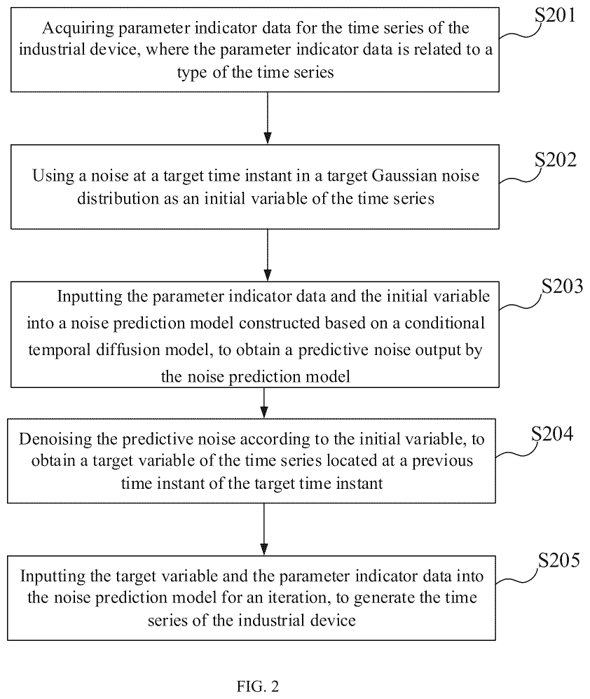

FIG. 2 is a flow diagram of a conditional temporal diffusion model-based method for generating a time series of an industrial device provided by an embodiment of the present application, as shown in FIG. 2, including:

S201, acquiring parameter indicator data for the time series of the industrial device, where the parameter indicator data is related to a type of the time series.

An executing subject of the embodiment in the present application is software and/or a hardware apparatus, and the hardware apparatus may be an electronic device or a processing chip in the electronic device.

In the embodiment of the present application, the parameter indicator data is used to indicate a type of a generated time series, for example, health indicator data of an engine, a gearbox, a bearing, a milling cutter, or a turbine. The noise prediction model may be constrained by the parameter indicator data so that a final generated time series is similar to an original time series.

In some embodiments, the parameter indicator data of the time series of the industrial device may be acquired from an external source. For example, the electronic device receives the parameter indicator data of the time series of the industrial device input by a user.

S202, using a noise at a target time instant in a target Gaussian noise distribution as an initial variable of the time series.

In the embodiment of the present application, a Gaussian noise refers to a type of noise whose probability density function obeys a Gaussian distribution (i.e., a normal distribution). A target Gaussian noise may be a type of noise acquired from an external source.

When determining the target Gaussian noise, the electronic device may perform random sampling, determine the target time instant, and acquire the noise corresponding to the target time instant from the target Gaussian noise distribution. In other words, the noise at the target time instant is acquired by randomly sampling from the Gaussian noise distribution.

For example, a variable x_{T} is drawn from a target Gaussian noise distribution N (0, I) at any time, i.e., x_{T}˜N (0, I).

When the noise at the target time instant is determined, the noise at the target time instant may be used as the initial variable for generating the time series.

S203, inputting the parameter indicator data and the initial variable into a noise prediction model constructed based on a conditional temporal diffusion model, to obtain a predictive noise output by the noise prediction model.

In the embodiment of the present application, the conditional temporal diffusion model may be a mathematical model based on Markov chains. The noise prediction model is a noise prediction model constructed based on the conditional temporal diffusion model and training thereof is completed, which may be used to generate a predictive noise including a sample time series feature.

The parameter indicator data and the initial variable are input into the noise prediction model to cause the noise prediction model to perform processing to generate the predictive noise.

S204, denoising the predictive noise according to the initial variable, to obtain a target variable of the time series located at a previous time instant of the target time instant.

In the embodiment of the present application, the denoising the predictive noise may be performing noise reduction on the predictive noise to obtain a variable at the previous time instant (e.g., a time instant t-1) i.e., gradually eliminating a noise included in the predictive noise and retaining a time series feature therein.

For example, the initial variable may be denoised in a way shown as follows:

$${x}_{t - 1} ← \frac{1}{\sqrt{{α}_{t}}} ( {x}_{t} - \frac{{β}_{t}}{\sqrt{1 - {\overline{α}}_{t}}} {ϵ}_{θ} ( {x}_{t} , t \vert {x}_{c} ) ) + \frac{1 - {\overline{α}}_{t - 1}}{1 - {\overline{α}}_{t}} {β}_{t} ϵ$$

where xₜ is a variable at a time instant t, E_{θ}(xₜ, t|x_{c}) is the predictive noise, βₜ is a variance parameter, αₜ=1−βₜ is a parameter, α̅ₜ=Πᵢ₌₁^{t} αᵢ is a parameter, and ∈˜N(0, I) is a random noise.

S205, inputting the target variable and the parameter indicator data into the noise prediction model for an iteration, to generate the time series of the industrial device.

In the embodiment of the present application, the target variable at the previous time instant (e.g., the time instant t-1) obtained after the denoising and the parameter indicator data are inputted into the noise prediction model to obtain a predictive noise corresponding to a time instant t-2 and outputted by the noise prediction model, and the predictive noise corresponding to the time instant t-2 is denoised to obtain a target variable corresponding to the time instant t-2.

A process of predicting and denoising with the model is performed in a loop iteration until the time instant t=0, where the resulting x₀ is the generated time series of the industrial device.

The embodiment of the present application provides a method for generating a time series of an industrial device, by acquiring parameter indicator data for the time series of the industrial device, where the parameter indicator data is related to a type of the time series; using a noise at a target time instant in a target Gaussian noise distribution as an initial variable of the time series; inputting the parameter indicator data and the initial variable into a noise prediction model constructed based on a conditional temporal diffusion model, to obtain a predictive noise output by the noise prediction model; denoising the predictive noise according to the initial variable, to obtain a target variable of the time series located at a previous time instant of the target time instant; and inputting the target variable and the parameter indicator data into the noise prediction model for an iteration, to generate the time series of the industrial device. The generation of the time series of the industrial device by means of the noise prediction model constructed based on the conditional temporal diffusion model relieves the problem existing in the prior art that it is difficult to converge in a model training process, thereby improving the efficiency of the time series of the industrial device.

Based on the embodiments described above, a process of obtaining the predictive noise is further described below.

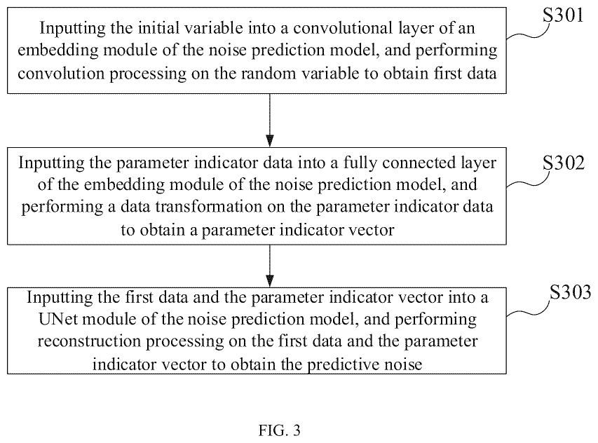

FIG. 3 is a flow diagram of generating a predictive noise provided by an embodiment of the present application, as shown in FIG. 3, including:

S301, inputting the initial variable into a convolutional layer of an embedding module of the noise prediction model, and performing convolution processing on the initial variable to obtain first data.

In the embodiment of the present application, the convolutional layer may be a 1-dimensional (1D) convolutional layer, and time series embedding may be performed on the initial variable through the 1D convolutional layer.

For example,

xₜ_{_{emb}}=Conv1D(xₜ)

where Conv1D(·) represents the 1D convolutional layer and x_{temb} represents an embedded time series, i.e., the first data.

S302, inputting the parameter indicator data into a fully connected layer of the embedding module of the noise prediction model, and performing a data transformation on the parameter indicator data to obtain a parameter indicator vector.

In the embodiment of the present application, the fully connected layer may be a structural layer with a two-layer fully connected (FC) network, and an activation function (e.g., a GeLU function) is included in each fully connected network.

For example,

x_{c}_{_{emb=}}FC(x_{c})

where FC(·) represents the fully connected layer and a position coding function, x_{c} is the parameter indicator data, and x_{c}_{_{emb}} is the parameter indicator vector.

In some embodiments, for processing on the parameter indicator data, extent of the parameter indicator data may further be adjusted by setting a parameter α. For an embedded parameter indicator vector, α therein will be set to a random value. For example, the larger a value of α, the larger the random value in the embedded parameter indicator vector, which will cause less parameter indicator data.

S303, inputting the first data and the parameter indicator vector into a UNet module of the noise prediction model, and performing reconstruction processing on the first data and the parameter indicator vector to obtain the predictive noise.

In the embodiment of the present application, when receiving the first data and the parameter indicator vector, the UNet module may perform processing on the first data and the parameter indicator vector by using different network structures.

For example, the performing, by the UNet module, the processing on the first data and the parameter indicator vector may include steps shown below:
A1, embedding the parameter indicator vector into the encoder layer and the decoder layer;
A2, inputting the first data into the encoder layer for encoding processing, to obtain second data;
A3, inputting the second data into the temporal decomposition reconstruction layer for temporal decomposition reconstruction processing, to obtain third data; and
A4, inputting the third data into the decoder layer for decoding processing to obtain fourth data, and inputting the fourth data into the convolutional layer for convolution processing, to obtain the predictive noise.

In some embodiments, please continue to refer to FIG. 1, the encoder layer in the UNet module may include three encoders, and each of the encoders includes two consecutive 1D convolutional blocks followed by a downsampling operation. Each of the convolutional blocks includes two convolutional layers.

The decoder layer may include three decoders, and each of the encoders includes two consecutive 1D convolutional blocks followed by an upsampling operation, each of the convolutional blocks including two convolutional layers.

When the parameter indicator vector is received, the parameter indicator vector may be embedded into each of the encoders in the encoder layer and each of the decoders in the decoder layer, so that the encoders and the decoders perform data processing in such a way that processed data includes information related to the parameter indicator vector as much as possible, thereby enhancing relevance of subsequent time series generation.

The first data is input into each of the encoders in the encoder layer for encoding processing to obtain second data, the second data is input into each of the layers in the temporal decomposition reconstruction layer for temporal decomposition reconstruction processing to obtain third data, the third data is input into each of the decoders in the decoder layer for decoding processing to obtain fourth data, and the fourth data is input into the convolutional layer for convolution processing to obtain the predictive noise.

It should be understood that the encoder layer, the decoder layer, and the temporal decomposition reconstruction layer include a plurality of network structures, and that when data processing is performed, input data is an output result of a previous network structure. For example, the encoder layer includes three encoders, and input data of a second encoder is an output result of a first encoder.

In the embodiment of the present application, in order to enhance the noise prediction model to learn a complex time pattern in the context of time series generation, so that a final generated time series has a high similarity with an original time series, the temporal decomposition reconstruction layer (time series decomposition technology) is introduced in a model processing process, and extraction of an underlying pattern and trend information of a time series by the temporal decomposition reconstruction layer can increase similarity between a generated time series and a real time series.

A processing process of the temporal decomposition reconstruction layer is described below.

For example, the second data is input into a pooling layer for pooling processing to obtain target feature data; the target feature data includes peak feature data and trend feature data; and the peak feature data and the trend feature data are input, after being concatenated, into a convolutional layer and an attention layer for processing to obtain the third data.

In some embodiments, average pooling processing is performed on the second data to obtain the trend feature data; and maximum pooling processing is performed on the second data to obtain the peak feature data.

In the embodiment of the present application, the temporal decomposition reconstruction layer may include three types: the pooling layer, the convolutional layer and the attention layer.

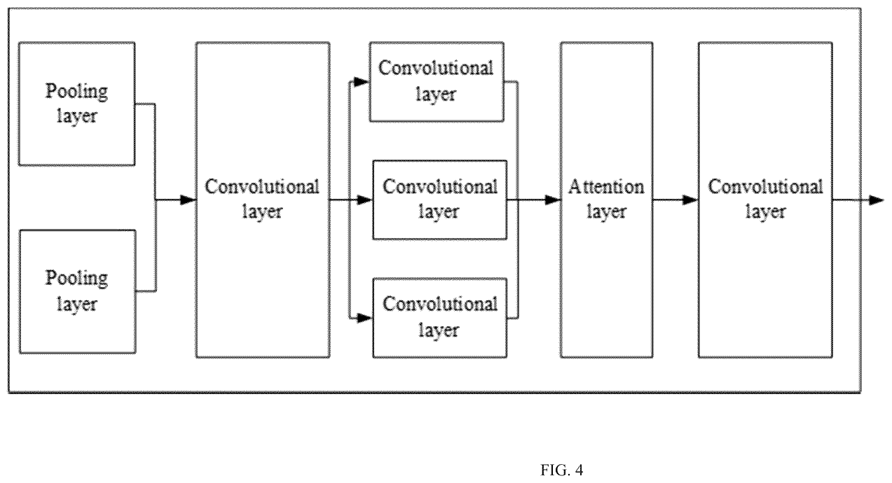

In one possible implementation, a connection relationship thereof can be shown in FIG. 4, including two pooling layers, five convolutional layers, and the attention layer.

The second data is input to the pooling layers for pooling processing, respectively, and average pooling and maximum pooling are used to decompose the second data to generate peak feature data and trend feature data. The peak feature data and the trend feature data are concatenated and then input into the convolutional layers for time series feature concatenation.

In one possible implementation, when the average pooling and the maximum pooling are used to decompose the second data to generate the peak feature data and the trend feature data, a same pooling layer may be used for processing with different pooling methods, or different pooling layers may be used for processing, which is not limited by the embodiment of the present application.

A concatenated time series feature is input into three 1-dimensional convolutional layers for processing to generate a separated feature, then an attention mechanism is executed for feature extraction, and finally the third data is generated by processing through the 1-dimensional convolutional layer.

For example, for the input second data (X), a process of the time series feature concatenation may be represented in a way shown as follows:

X_{Trend}=AvgPool(Padding(X))

X_{Peak}=MaxPool(Padding(X))

F_{dec}=Conv1d(Concat(X_{Trend},X_{Peak}))

where X_{Trend} is the trend feature data, X_{Peak} is the peak feature data, AvgPool(Padding(X)) represents the average pooling processing of X, MaxPool(Padding(X)): represents the maximum pooling processing of X, and F_{dec} represents a processing result of convolution after the concatenation.

After the time series feature concatenation is performed, a convolutional attention structure may be executed to reconstruct a multi-sensor time series. First, the separated feature is generated by processing a time series through the three 1-dimensional convolutional layers, and then the attention mechanism is executed as follows:

$${Q}_{conv} = Conv ( {F}_{dec} ) \\ {K}_{conv} = Conv ( {F}_{dec} ) \\ {V}_{conv} = Conv ( {F}_{dec} ) \\ Attention ( Q , K , V ) = softmax ( \frac{{Q}_{conv} {K}_{conv}^{T}}{\sqrt{{d}_{k}}} ) {V}_{conv}$$

where Q_{conv}, K_{conv}, V_{conv} are parameter matrices, and \sqrt{dₖ} is a scaling factor.

In conclusion, the method for generating a predictive noise provided by the embodiment of the present application, by introducing a temporal decomposition reconstruction (TDR) mechanism, can cause similarity between a time series feature included in the generated noise and an original time series feature to be high, thereby improving accuracy of the generated time series of the industrial device.

On the basis of the embodiments described above, a training process of the noise prediction model is described below.

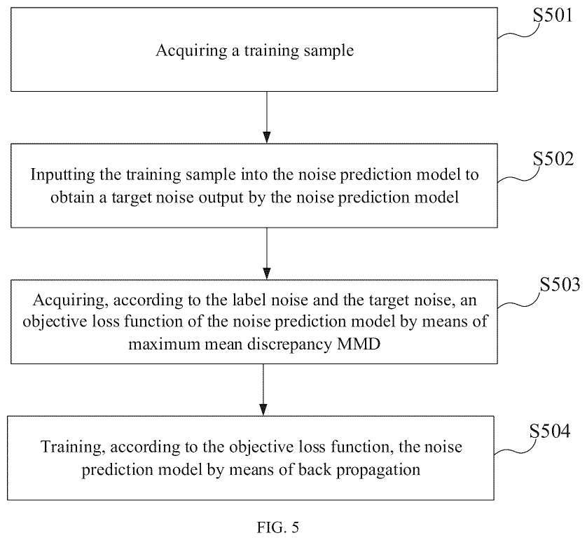

FIG. 5 is a flow diagram of a training method for the noise prediction model provided by an embodiment of the present application, as shown in FIG. 5, including:

S501, acquiring a training sample, where the training sample includes a sample time series of at least one industrial device, parameter indicator data for the sample time series, a time step of the sample time series, and a label noise.

In the embodiment of the present application, the time step is a difference value between one previous time point and one subsequent time point, i.e., a difference value between discrete data in the sample time series. The label noise is used for performing noise diffusion on the sample time series. It may be acquired from the target Gaussian noise distribution.

S502, inputting the training sample into the noise prediction model to obtain a target noise output by the noise prediction model.

In some embodiments, the noise prediction model outputs the target noise based on the training sample in a way that may be shown below.

For example, the noise diffusion is performed on the sample time series to obtain a latent variable of the sample time series; the latent variable of the sample time series is inputted into the convolutional layer of the embedding module of the noise prediction model, and convolution processing is performed on the latent variable to obtain fifth data; the parameter indicator data for the sample time series and the time step are inputted into the fully connected layer of the embedding module of the noise prediction model for data processing respectively to obtain sixth data; and the fifth data and the sixth data are inputted into a UNet module of the noise prediction model, and reconstruction processing is performed on the fifth data and the sixth data to obtain the target noise.

For example, the UNet module includes an encoder layer, a temporal decomposition reconstruction layer, a decoder layer, and a convolutional layer, and the reconstruction processing performed on the fifth data and the sixth data may include steps shown below:
B1, embedding the sixth data into the encoder layer and the decoder layer;
B2, inputting the fifth data into the encoder layer for encoding processing, to obtain seventh data;
B3, inputting the seventh data into the temporal decomposition reconstruction layer for temporal decomposition reconstruction processing, to obtain eighth data; and
B4, inputting the eighth data into the decoder layer for decoding processing to obtain ninth data, and inputting the ninth data into the convolutional layer for convolution processing, to obtain the target noise.

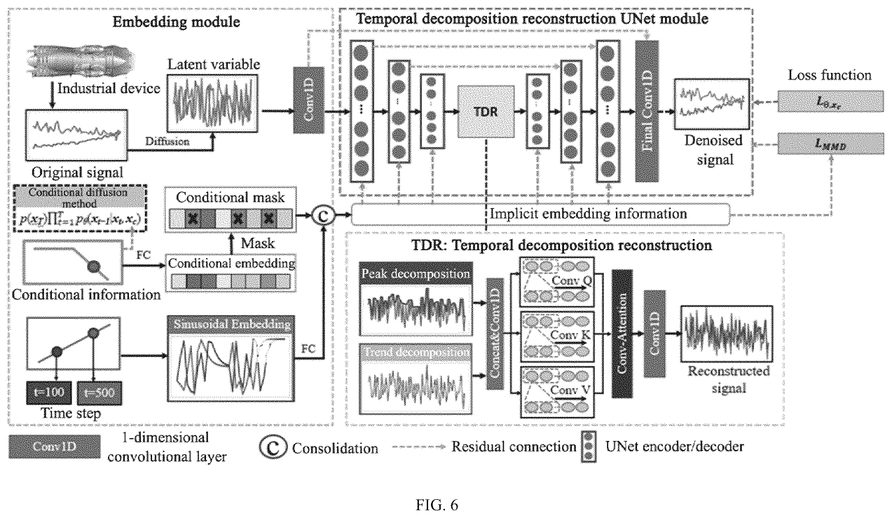

As shown in FIG. 6, the sample time series (original signal) is acquired, and the noise diffusion is performed on the sample time series by using the label noise, to obtain the latent variable.

For example, the noise diffusion of the sample time series may be similar to a process of conditional diffusion, which refers to a process of gradually adding a Gaussian noise to the sample time series until data becomes a random noise.

For original data (the sample time series) x₀˜q(x₀), each step of the diffusion process is to add the Gaussian noise to xₜ₋₁ from a previous step:

$$q ( {x}_{t} \vert {x}_{t - 1} ) = 𝒩 ( {x}_{t} ; \sqrt{1 - {β}_{t}} {x}_{t - 1} , {β}_{t} I )$$

[symbol]

is a noise distribution symbol and (0, I) is a distribution range of the Gaussian noise.

By continuously adding noise, as long as a total number of steps T of a diffusion process is large enough, then a final obtained X_{T} will infinitely approach a Gaussian random noise p(x_{T})= [symbol] (x_{T}; 0, I), and a whole diffusion process is a Markov chain:

$$q ( {x}_{1 : T} \vert {x}_{0} ) = {\prod }_{t = 1}^{T} q ( {x}_{t} \vert {x}_{t - 1} )$$

In an actual diffusion process, sampling may be performed on xₜ at any t step directly based on original data x₀ to obtain xₜ˜q(xₜ|x₀).

Let αₜ=1−βₜ and α̅ₜ̅=Πᵢ₌₁^{t} αᵢ, the following can be obtained using a reparameterization trick:

$${x}_{t} = \sqrt{\overline{{α}_{t}}} {x}_{0} + \sqrt{1 - {\overline{α}}_{t}} ϵ$$

where ∈˜N(0, I), this method can complete noise addition in a forward process by only one calculation, without gradual noise addition. A noise series (the latent variable) after diffusion is obtained through the diffusion process.

Processing of the parameter indicator data is similar to that in the embodiments described previously, which will not be repeated here.

For the time step, a discrete time step t is embedded into a continuous time feature t_{emb} by using sinusoidal embedding with a two-layer fully connected (FC) network, causing the noise prediction network to make sense of time-varying data.

tₚₒₛ=PosEmbed(t)

t_{emb}=FC(GeLU(FC(tₚₒₛ.

where tₚₒₛ is a time code, PosEmbed(·) represents a sinusoidal position embedding method, and GeLU is an activation function.

The processed parameter indicator data and the time step are consolidated and then embedded into the encoder layer and the decoder layer in the UNet module. The latent variable is convolved and then input into the UNet module for processing.

A process of outputting, by the UNet module, a target noise based on input data is similar to the process of outputting the predictive noise in the embodiments described above, which will not be repeated here.

S503, acquiring, according to the label noise and the target noise, an objective loss function of the noise prediction model by means of maximum mean discrepancy (MMD).

In the embodiment of the present application, when receiving the input latent variable, the UNet module may learn the latent variable, output the predictive noise, and perform noise reduction on the predictive noise, i.e., restore xₜ to x₀. A process of the noise reduction on the latent variable is similar to the diffusion process, which may also be defined by a Markov chain:

$${p}_{θ} ( {x}_{t - 1} \vert {x}_{t} ) = p ( {x}_{T} ) {\prod }_{t = 1}^{T} {p}_{θ} ( {x}_{t - 1} \vert {x}_{t} )$$

Parameter indicator data (x_{c}) is added in the noise reduction for the latent variable, and adding the parameter indicator data to a noise reduction process, the noise reduction process may satisfy equations shown below:

$${p}_{θ} ( {x}_{0 : T} \vert {x}_{c} ) := p ( {x}_{T} ) {\prod }_{t = 1}^{T} {p}_{θ} ( {x}_{t - 1} \vert {x}_{t} , {x}_{c} ) \\ {p}_{θ} ( {x}_{t - 1} \vert {x}_{t} , {x}_{c} ) := 𝒩 ( {x}_{t - 1} ; {μ}_{θ} ( {x}_{t} , t \vert {x}_{c} ) , {σ}_{θ} ( {x}_{t} , t \vert {x}_{c} ) I )$$

where μ_{θ} and σ_{θ} are process parameters, which may be defined by following equations:

$${μ}_{θ} ( {x}_{t} , t \vert {x}_{c} ) = \frac{1}{\sqrt{{α}_{t}}} ( {x}_{t} - \frac{{β}_{t}}{\sqrt{1 - {α}_{t}}} {ϵ}_{θ} ( {x}_{t} , t \vert {x}_{c} ) ) \\ {σ}_{θ} ( {x}_{t} , t \vert {x}_{c} ) = \frac{1 - {\overline{α}}_{t - 1}}{1 - {\overline{α}}_{t}} {β}_{t}$$

When training is performed on the noise prediction model, a loss function may be determined by minimizing loss of noise estimation. To increase similarity between the generated time series and the real time series, the loss function is regularized by introducing Maximum Mean Discrepancy (MMD) in the loss function, which serves as a final objective loss function.

For example, a noise estimation loss function is acquired according to the label noise and the target noise; the label noise and the target noise are mapped to a target dimension space to acquire a similarity function between the label noise and the target noise; and the objective loss function is obtained according to the noise estimation loss function and the similarity function.

For example, the noise estimation loss function may satisfy an equation shown below:

$${L}_{θ , {x}_{c}} = {𝔼}_{{x}_{0} \sim D , ϵ \sim N ( 0 , I ) , t} {‖ ϵ - {ϵ}_{θ} ( {x}_{t} , t \vert {x}_{c} ) ‖}_{2}^{2}$$

where D is sample time series distribution, € is a sample noise, and E is a mathematical expectation symbol of error.

The similarity function may satisfy an equation shown below:

$${L}_{MMD} ( n , m ) = K ( n , {n}^{′} ) - 2 K ( m , n ) + K ( m , {m}^{′} )$$

where K(·) represents a positive definite kernel function (a kernel matrix) designed to reproduce distribution in a high feature dimension space, and n′ and m′ are respectively values of n and m after a positive definite kernel function process.

n and m may be defined by equations shown below:

$$withn = ϵ \\ m = {ϵ}_{θ} ( {x}_{t} , t \vert {x}_{c} )$$

The noise estimation loss function and the similarity function are determined, and processing may be performed on the noise estimation loss function and the similarity function to obtain the objective loss function.

For example, additive processing is performed on the noise estimation loss function and the similarity function to obtain the objective loss function.

The objective loss function may satisfy an equation shown below:

$${L}_{diff} = {L}_{θ , {x}_{c}} + {L}_{MMD} ( n , m )$$

In some embodiments, the objective loss function may also be as follows:

$${L}_{diff} = {L}_{θ , {x}_{c}} + λ {L}_{MMD} ( n , m )$$

where λ is a balancing hyperparameter and may be used for adjusting the objective loss function to improve convergence speed of the objective loss function. For example, A may be set to 0.1.

S504, training, according to the objective loss function, the noise prediction model by means of back propagation.

In the embodiment of the present application, the noise prediction model is iteratively trained by means of back propagation according to the objective loss function, and training of the noise prediction model is completed when the objective loss function converges.

It should be understood that a trained noise prediction model may be based on a time series feature input during training, and in use, given only conditional information and a random noise, a predictive noise including the time series feature may be generated.

The method for training a noise prediction model provided in the embodiment of the present application, can improve the similarity between the generated time series and the real time series by adding a similarity function to a loss function.

An embodiment of the present application further provides a conditional temporal diffusion model-base apparatus for generating a time series of an industrial device.

FIG. 7 is a structure diagram of a conditional temporal diffusion model-based apparatus 70 for generating a time series of an industrial device provided by an embodiment of the present application, as shown in FIG. 7, including:
an acquiring module 701 configured to acquire parameter indicator data for the time series of the industrial device, where the parameter indicator data is related to a type of the time series;
a determining module 702, configured to use a noise at a target time instant in a target Gaussian noise distribution as an initial variable of the time series;
a processing module 703, configured to input the parameter indicator data and the initial variable into a noise prediction model constructed based on a conditional temporal diffusion model, to obtain a predictive noise output by the noise prediction model;
a denoising module 704, configured to denoise the predictive noise according to the initial variable, to obtain a target variable of the time series located at a previous time instant of the target time instant; and
an iterating module 705, configured to input the target variable and the parameter indicator data into the noise prediction model for an iteration, to generate the time series of the industrial device.

In one embodiment, the processing module 703 is further configured to input the initial variable into a convolutional layer of an embedding module of the noise prediction model, and perform convolution processing on the initial variable to obtain first data; input the parameter indicator data into a fully connected layer of the embedding module of the noise prediction model, and perform a data transformation on the parameter indicator data to obtain a parameter indicator vector; and input the first data and the parameter indicator vector into a UNet module of the noise prediction model, and perform reconstruction processing on the first data and the parameter indicator vector to obtain the predictive noise.

In one embodiment, the processing module 703 is further configured to embed the parameter indicator vector into the encoder layer and the decoder layer; input the first data into the encoder layer for encoding processing, to obtain second data; input the second data into the temporal decomposition reconstruction layer for temporal decomposition reconstruction processing, to obtain third data; and input the third data into the decoder layer for decoding processing to obtain fourth data, and input the fourth data into the convolutional layer for convolution processing, to obtain the predictive noise.

In one embodiment, the processing module 703 is further configured to input the second data into the pooling layer for pooling processing, to obtain target feature data; where the target feature data includes peak feature data and trend feature data; and input after concatenating the peak feature data and the trend feature data into the convolutional layer and the attention layer for processing to obtain the third data.

In one embodiment, the apparatus 70 for generating the time series further includes: a training module 706.

The training module 706 is configured to acquire a training sample, where the training sample includes a sample time series of at least one industrial device, parameter indicator data for the sample time series, a time step of the sample time series, and a label noise; input the training sample into the noise prediction model to obtain a target noise output by the noise prediction model; acquire an objective loss function of the noise prediction model by means of maximum mean discrepancy (MMD) according to the label noise and the target noise; and train the noise prediction model by means of back propagation according to the objective loss function.

In one embodiment, the training module 706 is further configured to input the sample time series into a diffusion layer of an embedding module for noise diffusion, to obtain a latent variable of the sample time series; input the latent variable of the sample time series into a convolutional layer of the embedding module, and perform convolution processing on the latent variable to obtain fifth data; input the parameter indicator data and the time step into the fully connected layer of the embedding module for data processing respectively to obtain sixth data; and input the fifth data and the sixth data into a UNet module for processing, to obtain the target noise.

In one embodiment, the training module 706 is further configured to acquire, according to the label noise and the target noise, a noise estimation loss function; map the label noise and the target noise to a target dimension space to obtain a similarity function between the label noise and the target noise; and obtain the objective loss function according to the noise estimation loss function and the similarity function.

In one embodiment, the training module 706 is further configured to perform additive processing on the noise estimation loss function and the similarity function to obtain the objective loss function.

The conditional temporal diffusion model-based apparatus for generating a time series of an industrial device provided by the embodiment of the present application may execute the conditional temporal diffusion model-based method for generating a time series of an industrial device provided in any of the embodiments described above, which is similar in principle and technical effect and will not be repeated here.

An embodiment of the present application further provides an electronic device.

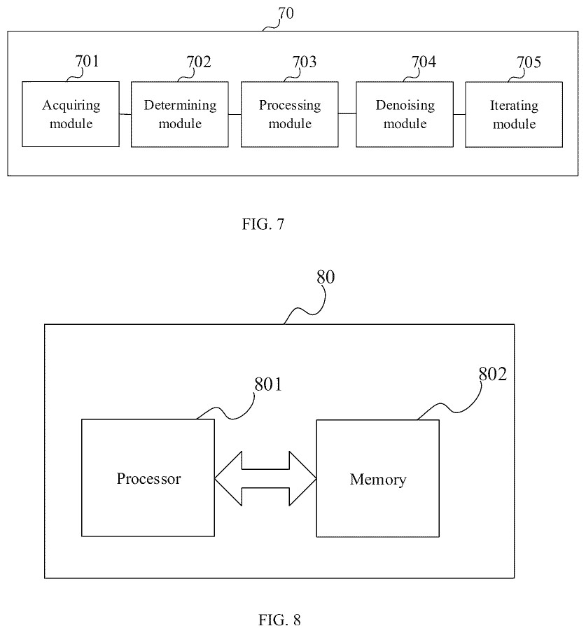

FIG. 8 is a structure diagram of an electronic device 80 provided by an embodiment of the present application, as shown in FIG. 8, including:
a processor 801; and
a memory 802, configured to store an executable instruction for a terminal device.

Specifically, a program may include a program code, and the program code includes a computer operation instruction. The memory 802 may include a high speed RAM memory or may also include a non-volatile memory, for example, at least one disk memory.

The processor 801 is configured to execute a computer executable instruction stored in the memory 802, to implement a technical solution of the conditional temporal diffusion model-based method embodiment for generating a time series of an industrial device described in the preceding method embodiments.

The processor 801 may be a central processing unit (CPU), or an application specific integrated circuit (ASIC), or one or more integrated circuits configured to implement the embodiments of the present application.

In one embodiment, the electronic device 80 may further include a communication interface 803 to enable a communication interaction with an external device via the communication interface 803, and the external device may be, for example, a user terminal (e.g., a mobile phone, a tablet). In a specific implementation, if the communication interface 803, the memory 802, and the processor 801 are implemented independently, the communication interface 803, the memory 802, and the processor 801 may be connected to each other and complete communication with each other via a bus.

The bus may be an industry standard architecture (ISA) bus, a peripheral component interconnect (abbreviated as PCI) bus or an extended industry standard architecture (EISA) bus, etc. The bus may be categorized as address bus, data bus, control bus, etc., which does not represent that there is only one bus or one type of bus.

In one embodiment, in a specific implementation, if the communication interface 803, the memory 802, and the processor 801 are integrated and implemented on a single chip, the communication interface 803, the memory 802, and the processor 801 may complete communication via an internal interface.

An embodiment of the present application further provides a computer readable storage medium on which a computer program is stored, and when being executed by a processor, the computer program implements the technical solution of the conditional temporal diffusion model-based method for generating a time series of an industrial device described in the above embodiments, which is similar in principle and technical effect and will not be repeated here.

In one possible implementation, the computer readable medium may include a random access memory (RAM), a read-only Memory (ROM), a compact disc read-only memory (CD-ROM) or other optical disk memory, a disk memory or other magnetic storage device, or any other medium targeted to carry or store a desired program code in a form of instructions or data structures and accessible by a computer. Further, any connection is appropriately referred to as a computer readable medium. For example, if a coaxial cable, a fiber optic cable, a twisted pair cable, a digital subscriber line (DSL), or a wireless technology (e.g., infrared, radio, and microwave) is used to transmit software from a web site, a server, or other remote source, then the coaxial cable, the fiber optic cable, the twisted pair cable, the DSL, or the wireless technologies such as infrared, radio, and microwave are included in the definition of medium. As used herein, a disk and an optical disk include a compact disc, a laser disc, an optical disk, a digital versatile disc (DVD), a floppy disk, and a Blu-ray disc, where the disk typically reproduces data magnetically and the optical disk reproduces data optically with lasers. A combination of the above should also be included in the scope of computer readable medium.

An embodiment of the present application further provides a computer program product, including a computer program, and when being executed by a processor, the computer program implements the technical solution of the conditional temporal diffusion model-based method for generating a time series of an industrial device described in the above embodiments, which is similar in principle and technical effect and will not be repeated here.

In a specific implementation of the terminal device or the server described above, it should be understood that a processor may be a central processing unit (CPU), or other general purpose processor, a digital signal processor (DSP), an application specific integrated circuit (ASIC), etc. The general purpose processor may be a microprocessor or the processor may be any conventional processor. Steps of the method disclosed in combination with the embodiments of the present application may be directly embodied as being executed by a hardware processor, or being executed completely by a combination of hardware and software modules in the processor.

Those skilled in the art can understand that all or part of steps in any of the above-mentioned method embodiments may be finished by hardware associated with program instructions. The foregoing program may be stored in a computer readable storage medium, and when being executed, the program executes all or part of the steps in the above-mentioned method embodiments.

The technical solution of the present application may be stored in a computer readable storage medium if it is implemented in a form of software and sold or used as a product. Based on this understanding, all or part of the technical solution of the present application may be embodied in a form of a software product, and the computer software product is stored in a storage medium and includes a computer program or a number of instructions. The computer software product causes a computer device (which may be a personal computer, a server, a network device, or a similar electronic device) to execute all or part of the steps of the method described in the embodiments of the present application.

It should be noted that, the foregoing method embodiments are all expressed as a series of action combinations for the sake of simplicity of description, but those skilled in the art should be aware that the present application is not limited by the order of the described actions, because according to the present application, some of the steps may be performed in other sequences or at the same time. Secondly, those skilled in the art should also be aware that the embodiments described in the specification are optional embodiments, and the actions and modules involved are not necessarily necessary for the present application.

It is further noted that although various steps in the flow diagram are shown sequentially as indicated by arrows, these steps are not necessarily executed sequentially in the order indicated by the arrows. Unless expressly stated herein, there is no strict order limitation on the execution of these steps, and the steps may be executed in other orders. Moreover, at least a part of the steps in the flow diagram may include a plurality of sub-steps or a plurality of phases, and these sub-steps or phases are not necessarily executed completely at the same time instant but may be executed at different time instants, and these sub-steps or phases are not necessarily executed in a sequential order, but may be executed in turn or alternatively with at least a part of other steps or sub-steps or phases of the other steps.

It should be understood that the above-mentioned apparatus embodiments are only schematic, and the apparatus of the present application may be implemented in other ways. For example, division of units/modules in the above-mentioned embodiments is only a logical functional division, and there may be other ways of division in actual implementation. For example, a plurality of units, modules or components may be combined, or may be integrated into another system, or some features may be ignored or not executed.

In addition, if not otherwise specified, various functional units/modules in the various embodiments of the present application may be integrated in a single unit/module, or the various units/modules may physically exist separately, or two or more units/modules may be integrated together. The above-mentioned integrated unit/module may be implemented in a form of hardware or in a form of a software program module.

When the integrated unit/module is implemented as hardware, the hardware may be a digital circuit, an analog circuit, etc. Physical implementations of a hardware structure include, but are not limited to, a transistor, a memristor, etc. If not otherwise specified, the processor may be any suitable hardware processor, for example, a CPU, a GPU, an FPGA, a DSP, an ASIC, etc. If not otherwise specified, a storage unit may be any suitable magnetic storage medium or magneto-optical storage medium, for example, a resistive random access memory (RRAM), a dynamic random access memory (DRAM), a static random-access memory (SRAM), an enhanced dynamic random access memory (EDRAM), a high-bandwidth memory (HBM), a hybrid memory cube (HMC), etc.

The integrated unit/module may be stored in a computer readable memory when implemented as a software program module and sold or used as a stand-alone product. Based on this understanding, the technical solution of the present application in essence, or in other word, the part which contributes to the prior art, or all or part of the technical solution may be embodied in a form of a software product, and the computer software product is stored in a memory including a number of instructions which cause a computer device (which may be a personal computer, a server, or a network device, etc.) to execute all or part of the steps in the methods in various embodiments of the present application. The foregoing memory includes: a USB flash drive, a read-only memory (ROM), a random access memory (RAM), a mobile hard disk, diskette, or CD-ROM, and other media which can store program codes.

In the above-mentioned embodiments, the description of each embodiment has its own focus, and for the part which is not described in detail in a certain embodiment, a relevant description of other embodiments may be referred to. Various technical features of the above-mentioned embodiments may be combined in any way. For the sake of conciseness, all possible combinations of the various technical features of the above-mentioned embodiments have not been described, however, they should be considered to be within the scope of the present specification as long as there is no contradiction in the combinations of these technical features.

Finally, it should be noted that the above embodiments are only used to explain the technical solutions of the present application, not to limit them; although the present application has been described in detail with reference to the foregoing embodiments, the person of ordinary skill in the art should understand that: the person of ordinary skill in the art can still make modifications to the technical solutions recorded in the foregoing embodiments, or make equivalent substitutions for part or all of the technical features therein; and such modifications or substitutions do not take the essence of a corresponding technical solution out of the scope of the technical solutions of the embodiments in the present application.

What is claimed is:

1. A conditional temporal diffusion model-based method for generating a time series of an industrial device, comprising:
acquiring parameter indicator data for the time series of the industrial device, wherein the parameter indicator data is related to a type of the time series;
using a noise at a target time instant in a target Gaussian noise distribution as an initial variable of the time series;
inputting the parameter indicator data and the initial variable into a noise prediction model constructed based on a conditional temporal diffusion model, to obtain a predictive noise output by the noise prediction model;
denoising the predictive noise according to the initial variable, to obtain a target variable of the time series located at a previous time instant of the target time instant; and
inputting the target variable and the parameter indicator data into the noise prediction model for an iteration, to generate the time series of the industrial device.

2. The method according to claim 1, wherein the inputting the parameter indicator data and the initial variable into the noise prediction model constructed based on the conditional temporal diffusion model, to obtain the predictive noise output by the noise prediction model comprises:
inputting the initial variable into a convolutional layer of an embedding module of the noise prediction model, and performing convolution processing on the initial variable to obtain first data;
inputting the parameter indicator data into a fully connected layer of the embedding module of the noise prediction model, and performing a data transformation on the parameter indicator data to obtain a parameter indicator vector; and
inputting the first data and the parameter indicator vector into a UNet module of the noise prediction model, and performing reconstruction processing on the first data and the parameter indicator vector to obtain the predictive noise.

3. The method according to claim 2, wherein the UNet module comprises an encoder layer, a temporal decomposition reconstruction layer, a decoder layer, and a convolutional layer, and the performing the reconstruction processing on the first data and the parameter indicator vector to obtain the predictive noise comprises:
embedding the parameter indicator vector into the encoder layer and the decoder layer;
inputting the first data into the encoder layer for encoding processing, to obtain second data;
inputting the second data into the temporal decomposition reconstruction layer for temporal decomposition reconstruction processing, to obtain third data; and
inputting the third data into the decoder layer for decoding processing to obtain fourth data, and inputting the fourth data into the convolutional layer for convolution processing, to obtain the predictive noise.

4. The method according to claim 3, wherein the temporal decomposition reconstruction layer comprises: a pooling layer, a convolutional layer, and an attention layer; and the inputting the second data into the temporal decomposition reconstruction layer for the temporal decomposition reconstruction processing, to obtain the third data comprises:
inputting the second data into the pooling layer for pooling processing, to obtain target feature data; wherein the target feature data comprises peak feature data and trend feature data; and
inputting after concatenating the peak feature data and the trend feature data into the convolutional layer and the attention layer for processing, to obtain the third data.

5. The method according to claim 4, wherein the inputting the second data into the pooling layer for the pooling processing, to obtain the target feature data comprises:
performing average pooling processing on the second data to obtain the trend feature data; and
performing maximum pooling processing on the second data to obtain the peak feature data.

6. The method according to claim 1, further comprising:
acquiring a training sample, wherein the training sample comprises a sample time series of at least one industrial device, parameter indicator data for the sample time series, a time step of the sample time series, and a label noise;
inputting the training sample into the noise prediction model to obtain a target noise output by the noise prediction model;
acquiring, according to the label noise and the target noise, an objective loss function of the noise prediction model by means of maximum mean discrepancy (MMD); and
training, according to the objective loss function, the noise prediction model by means of back propagation.

7. The method according to claim 6, wherein the inputting the training sample into the noise prediction model to obtain the target noise output by the noise prediction model comprises:
inputting the sample time series into a diffusion layer of an embedding module of the noise prediction model for noise diffusion, to obtain a latent variable of the sample time series;
inputting the latent variable of the sample time series into a convolutional layer of the embedding module of the noise prediction model, and performing convolution processing on the latent variable to obtain fifth data;
inputting the parameter indicator data for the sample time series and the time step into a fully connected layer of the embedding module of the noise prediction model for data processing respectively to obtain sixth data; and
inputting the fifth data and the sixth data into a UNet module of the noise prediction model, and performing reconstruction processing on the fifth data and the sixth data to obtain the target noise.

8. The method according to claim 7, wherein the UNet module comprises an encoder layer, a temporal decomposition reconstruction layer, a decoder layer, and a convolutional layer, and the performing the reconstruction processing on the fifth data and the sixth data to obtain the target noise comprises:
embedding the sixth data into the encoder layer and the decoder layer;
inputting the fifth data into the encoder layer for encoding processing, to obtain seventh data;
inputting the seventh data into the temporal decomposition reconstruction layer for temporal decomposition reconstruction processing, to obtain eighth data; and
inputting the eighth data into the decoder layer for decoding processing to obtain ninth data, and inputting the ninth data into the convolutional layer for convolution processing, to obtain the target noise.

9. The method according to claim 6, wherein the acquiring, according to the label noise and the target noise, the objective loss function of the noise prediction model by means of the maximum mean discrepancy (MMD) comprises:
acquiring a noise estimation loss function according to the label noise and the target noise;
mapping the label noise and the target noise to a target dimension space, to obtain a similarity function between the label noise and the target noise; and
obtaining the objective loss function according to the noise estimation loss function and the similarity function.

10. The method according to claim 9, wherein the obtaining the objective loss function according to the noise estimation loss function and the similarity function comprises:
performing additive processing on the noise estimation loss function and the similarity function to obtain the objective loss function.

11. The method according to claim 1, wherein the parameter indicator data is used to indicate a type of the generated time series, and the parameter indicator data comprises at least one of: health indicator data of an engine, health indicator data of a gearbox, health indicator data of a bearing, health indicator data of a milling cutter, and health indicator data of a turbine.

12. A conditional temporal diffusion model-based apparatus for generating a time series of an industrial device, comprising:
a memory and a processor;
where the memory is configured to store a computer instruction; and the processor is configured to run the computer instruction stored in the memory to:
acquire parameter indicator data for the time series of the industrial device, wherein the parameter indicator data is related to a type of the time series;
use a noise at a target time instant in a target Gaussian noise distribution as an initial variable of the time series;
input the parameter indicator data and the initial variable into a noise prediction model constructed based on a conditional temporal diffusion model, to obtain a predictive noise output by the noise prediction model;
denoise the predictive noise according to the initial variable, to obtain a target variable of the time series located at a previous time instant of the target time instant; and
input the target variable and the parameter indicator data into the noise prediction model for an iteration, to generate the time series of the industrial device.

13. The apparatus according to claim 12, wherein the processor is further configured to run the computer instruction stored in the memory to:
input the initial variable into a convolutional layer of an embedding module of the noise prediction model, and perform convolution processing on the initial variable to obtain first data;
input the parameter indicator data into a fully connected layer of the embedding module of the noise prediction model, and perform a data transformation on the parameter indicator data to obtain a parameter indicator vector; and
input the first data and the parameter indicator vector into a UNet module of the noise prediction model, and perform reconstruction processing on the first data and the parameter indicator vector to obtain the predictive noise.

14. The apparatus according to claim 13, wherein the UNet module comprises an encoder layer, a temporal decomposition reconstruction layer, a decoder layer, and a convolutional layer, and the processor is further configured to run the computer instruction stored in the memory to:
embed the parameter indicator vector into the encoder layer and the decoder layer;
input the first data into the encoder layer for encoding processing, to obtain second data;
input the second data into the temporal decomposition reconstruction layer for temporal decomposition reconstruction processing, to obtain third data; and
input the third data into the decoder layer for decoding processing to obtain fourth data, and input the fourth data into the convolutional layer for convolution processing, to obtain the predictive noise.

15. The apparatus according to claim 14, wherein the temporal decomposition reconstruction layer comprises: a pooling layer, a convolutional layer, and an attention layer; and the processor is further configured to run the computer instruction stored in the memory to:
input the second data into the pooling layer for pooling processing, to obtain target feature data; wherein the target feature data comprises peak feature data and trend feature data; and
input after concatenating the peak feature data and the trend feature data into the convolutional layer and the attention layer for processing, to obtain the third data.

16. The apparatus according to claim 15, wherein the processor is further configured to run the computer instruction stored in the memory to:
perform average pooling processing on the second data to obtain the trend feature data; and
perform maximum pooling processing on the second data to obtain the peak feature data.

17. The apparatus according to claim 12, wherein the processor is further configured to run the computer instruction stored in the memory to:
acquire a training sample, wherein the training sample comprises a sample time series of at least one industrial device, parameter indicator data for the sample time series, a time step of the sample time series, and a label noise;
input the training sample into the noise prediction model to obtain a target noise output by the noise prediction model;
acquire, according to the label noise and the target noise, an objective loss function of the noise prediction model by means of maximum mean discrepancy (MMD); and
train, according to the objective loss function, the noise prediction model by means of back propagation.

18. The apparatus according to claim 15, wherein the parameter indicator data is used to indicate a type of the generated time series, and the parameter indicator data comprises at least one of: health indicator data of an engine, health indicator data of a gearbox, health indicator data of a bearing, health indicator data of a milling cutter, and health indicator data of a turbine.

19. A non-transitory computer readable storage medium storing a computer program, wherein the computer program is executed by a processor to:
acquire parameter indicator data for the time series of the industrial device, wherein the parameter indicator data is related to a type of the time series;
use a noise at a target time instant in a target Gaussian noise distribution as an initial variable of the time series;
input the parameter indicator data and the initial variable into a noise prediction model constructed based on a conditional temporal diffusion model, to obtain a predictive noise output by the noise prediction model;
denoise the predictive noise according to the initial variable, to obtain a target variable of the time series located at a previous time instant of the target time instant; and
input the target variable and the parameter indicator data into the noise prediction model for an iteration, to generate the time series of the industrial device.

20. The non-transitory computer readable storage medium according to claim 19, wherein the parameter indicator data is used to indicate a type of the generated time series, and the parameter indicator data comprises at least one of: health indicator data of an engine, health indicator data of a gearbox, health indicator data of a bearing, health indicator data of a milling cutter, and health indicator data of a turbine.
